(19) United States
(12) Patent Application Publication
(10) Pub. No.: US 2009/0031764 A1
(43) Pub. Date: Feb. 5, 2009

(54) Padlock having an indicator

(76) Inventor: Chien-Yung Huang, Banchiao City (TW)

Correspondence Address: PRO-TECHTOR INTERNATIONAL SERVICES, 20775 NORADA CT., SARATOGA, CA, 95070, US

(21) Appl. No.: 12/178,222

(22) Filed: Jul. 23, 2008

(30) Foreign Application Priority Data
Jul. 31, 2007 (TW) 096212546

(51) Int. Cl. E05B 37/00

(52) U.S. Cl. 70/21

(57) ABSTRACT

A padlock having an indicator, having an indicator window or a hood in the housing, the padlock enabling the dials of the housing to open and close the lock, a key can also be used to rotate the key tumbler to enable fore opening of the lock, when the dials are in the locked state, from the indicator window or a hood displaying the indication block, the confirm whether the inspector has unlocked for examining.

### BACKGROUND OF THE INVENTION

a) Field of the Invention

The present invention relates to a padlock having an indicator, more particularly, a housing can be provided with an indicator window or a hood, with the indicator window or a hood displaying the indication block, to confirm whether the inspector has unlocked for examining.

b) Description of the Prior Art

A conventional padlock uses a tube to enable opening or closing shackle of the lock, as shown in U.S. Pat. P. No. 2002/0088256 and Taiwan Pat. Public No. 590146, Accordingly, such the conventional padlocks have not indication block in a housing, a padlock user will not be able to confirm whether the inspector has unlocked for examining. Hence, there is need for improvement in the prior art.

### SUMMARY OF THE INVENTION

The primary object of the present invention is to provide a padlock having an indicator, namely to providing such padlocks with an indicator window, hence, the indicator window enables viewing the different colors of the first and second surfaces, thereby confirming whether the padlock have been examined.

Another object of the present invention is to provide a padlock having an indicator, wherein, a padlock with a hood in a housing, the indication block is provided with a tip in a housing, and the hood is provided with a tip hole for inserting with a tip, to fciliate a padlock user confirm whether the padlock have been examined.

To enable a further understanding of said objectives and the technological methods of the invention herein, a brief description of the drawings is provided below followed by a detailed description of the preferred embodiments.

### BRIEF DESCRIPTION Of THE DRAWINGS

FIG. 1 is a perspective view of the present invention.

FIG. 2 is an exploded perspective view the present invention.

FIG. 3 is a rear sectional view the present invention when in a locking position.

FIG. 4 is a rear sectional view of the present invention when in a locking position, and with the lock opened by a key.

FIG. 5 is a rear sectional view of the present invention when in a locking position, and with the lock closed by a key.

FIG. 6 is a rear sectional view of the present invention when in an unlocking position.

FIG. 7 is a cutaway view of the present invention, wherein when opening a lock by dials, a sharp object is used to press down a push button of an indicator.

FIG. 8 shows a rear sectional view of the embodiment according to the present invention.

FIG. 9 shows a rear sectional view of the embodirnent according to the present invention when in a locking position, and with the lock opened by a key.

FIG. 10 shows another rear sectional view of the embodiment according to the present invention, and the padlock is not provided with the dials and the sleeves.

FIG. 11 shows another rear sectional view of the embodiment according to the present invention when in a locking position, and with the lock opened by a key, and the padlock is not provided with the dials and the sleeves.

### DETAILED DESCRIPTION OF THE PREFERRED EMBODIMENTS

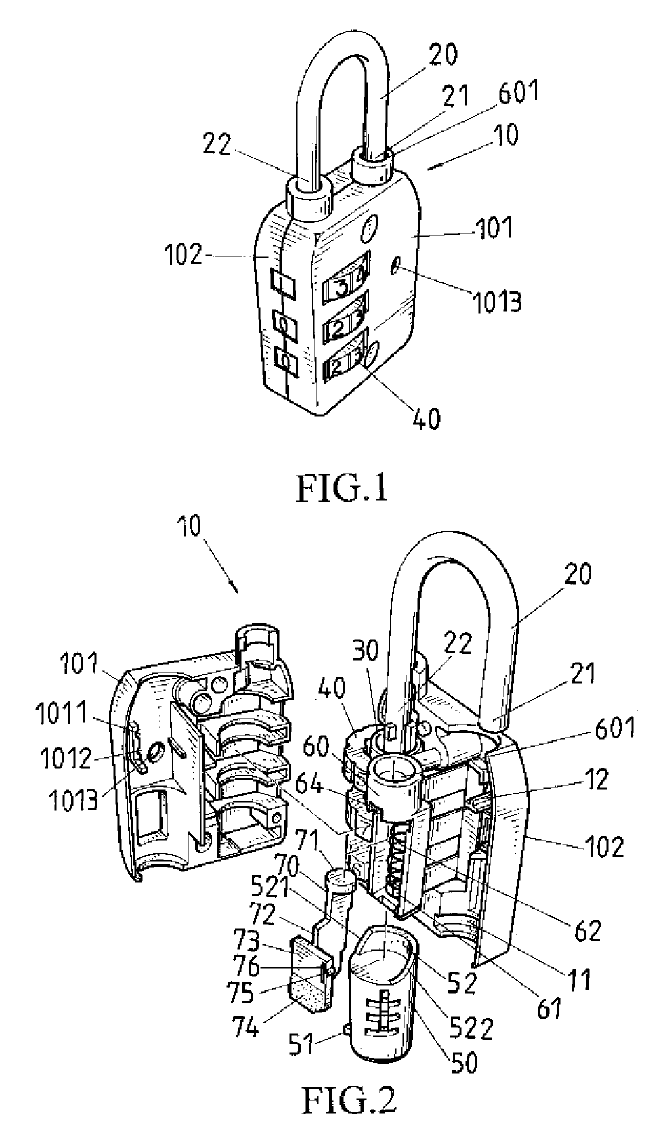

Referring to FIG. 1 and FIG. 2, apart from the padlock of the present invention enabling the dials 40 of the housing 10 to open and close the lock, a key can also be used to rotate the key tumbler 50 to enable force opening of the lock, which comprising a housing 10, a shackle 20, three sleeves 30, three dials 40, a key tumbler 50, a tube 60 and an indication block 70, wherein the housing 10 is configured with two shells 101, 102. A shackle 20 is configured with a short leg 21 and a long leg 22. Three sleeves are located on the housing 10, thereby enabling the long leg 22 of the shackle 20 to pass therethrough. Three dials 40 are respectively sleeve disposed with the sleeves 30, with outer rims of the dials 40 being exposed out of the housing 10.

The present invention is primarily characterized in that: A key tumbler 50 is provided with a bump 51 at an exterior side, the bump 51 is latched in an arc slot 11 of the housing to restrict a rotation angle of the key tumbler 50, a top end of the key tumbler 50 is provided with an arc block 52, and two side edges of the arc block 52 are provided with a left and a right slant surface 521, 522;

A tube 60 is provided with a hollow chamber 601 in an interior side, allowing the short leg 21 of the shackle 20 to be insert into the hollow chamber 601, an upper end of a spring 62 is abuted on a baffle block 12, a lower end is sheathed on a bump block 61, and a bottom of the tube 60 is provided with a push block 63;

An indication block 70 is located on the housing 10 and is provided with a switch button 71 which can be extended into the hollow chamber 601 of the tube 60, a central latch block 72 is extended into an indented hole 64 of the tube 60 for positioning, and the bottom of the indicator 70 is provided with a first surface 73 and second surface 74 of two different colors, wherein a color of green will be shown on the first surface 73, and a color of red will be shown on the second surface 74, next to an upper indicator 73 is provided with a bump 75, a place close to an edge of the bump 75 is provided with a slot 76 which has an elastic function, an interior of the shell 101 of the housing 10 is provided with two notches 1011, 1012 for positioning the bump 75, and the shell 101 of the housing 10 is configured with an indicator window 1013.

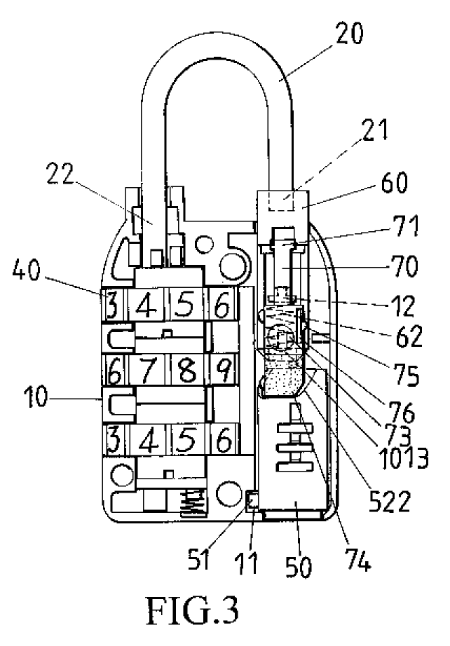

Referring to FIG. 3, it shows the padlock in a locking position, wherein the tube 60 is extended out of the housing 10 to lock the short leg 21 of the shackle 20, when a combination of numbers on the dials 40 have placed the lock in a locked state; in this case, a color of green will be shown on the first surface 73 when viewing from the indicator window 1013.

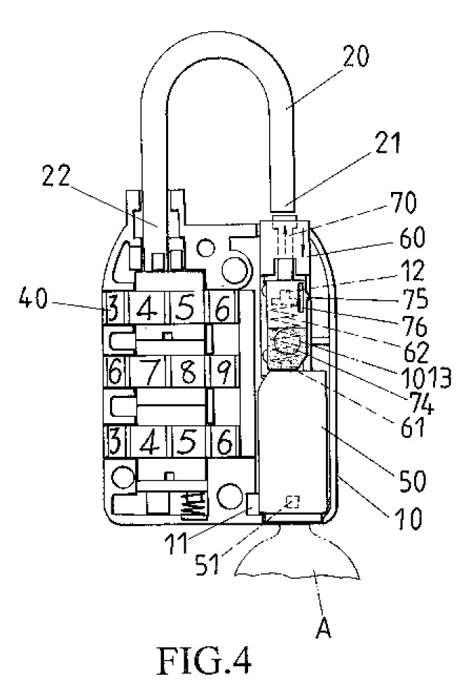

Referring to FIG. 4, a key A is inserted and the key tumbler 50 is turned counterclockwise for unlocking. Referring to FIG. 2, the left slant surface 521 of the key tumbler 50 provides the tube 60 to displace downward the indication block 70 displaces upward by a push of the right slant surface 522 of the key tumbler 50, and the bump 75 of the indication block 70 moves to the upper notch 1011 from the lower notch 1012 of the shell 101, wherein a color of red will be shown on the second surface 74 when viewing from the indicator window 1013.

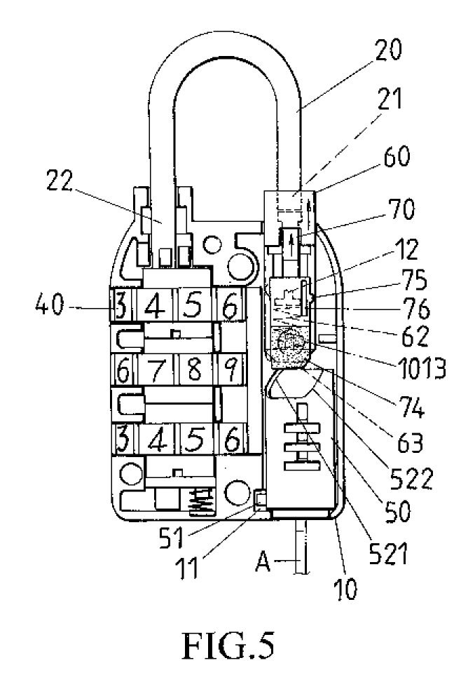

Referring to FIG. 5, the key A turns the key tumbler 50 clockwise for locking, the left slant surface 521 of the key tumbler 50 pushes the push block 63 of the tube 60 to push the tube 60 upward (at a same time, the spring 62 is compressed inward), so as to lock the short leg 21 of the shackle 20. In addition, the bump 75 of the indication block 70 is still in the notch 1011 on the shell 101 (as shown in FIG. 2), and a color of red will be still shown on the second surface 74 when viewing from the indicator windows 1013.

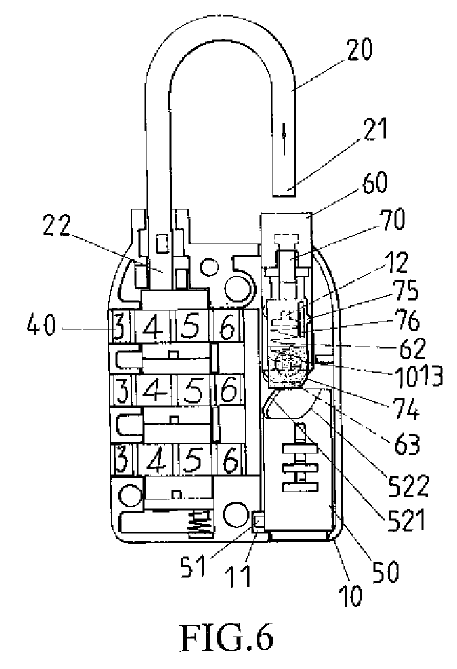

Referring to FIG. 6, when a combination of numbers on the dials 40 are such to enable opening the lock, the short leg 21 of the shackle 20 is pulled out to release from the tube 60, and then the lock is opened.

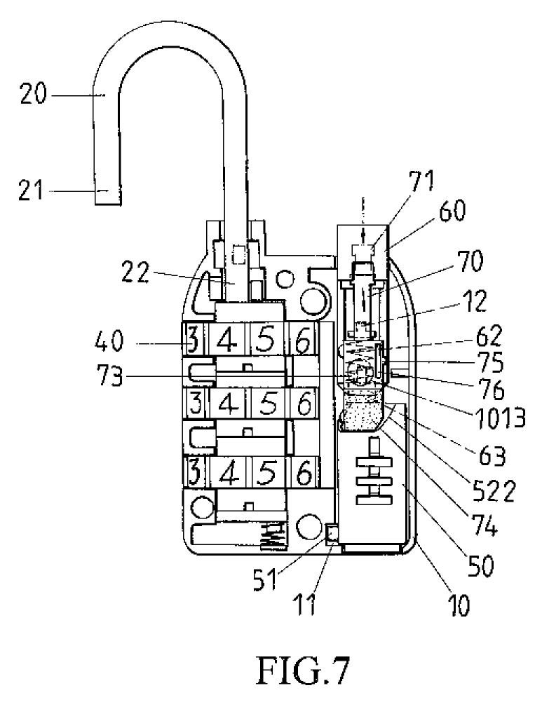

Referring to FIG. 7, when a combination of numbers on the dials 40 have placed the lock in a opened state, the short leg 21 of the shackle 20 is turned, the switch button 71 of the indication block 70 is protruded upward, and the switch button 71 is pressed down by a sharp object, enabling the bump 75 of the indication block 70 to move from the upper notch 75 to the lower notch 1012 on the shell 101 (as shown in FIG. 3), wherein a color of green will be shown on the first surface 73 when viewing from the indicator window 1013.

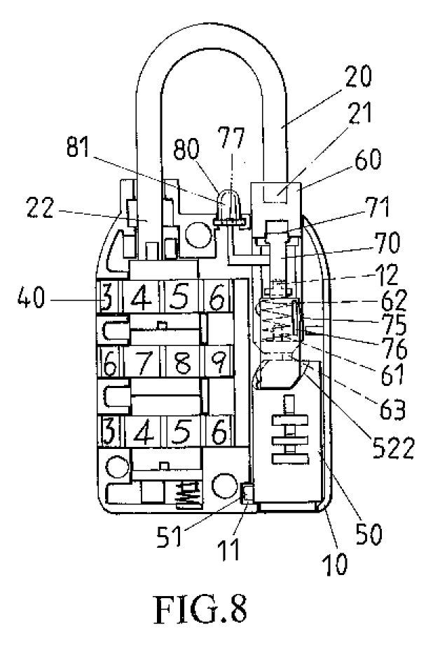

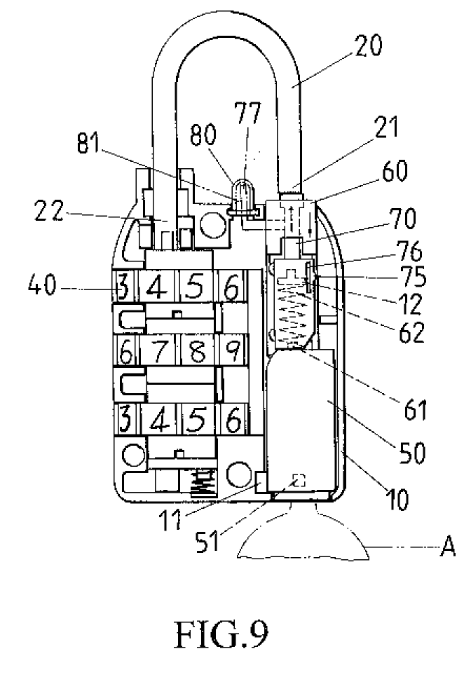

Referring to FIG. 8, the indication block 70 of present invention is not provided with a first surface and second surface of two different colors, the shell 101 of the housing 10 is not configured with an indicator window, the top of the housing 10 is configured with a hood 80, next to the indication block 70 is extended with a tip 77, an interior of the hood 80 is provided with an indented hole 81 to hold the tip 77, and the hood 80 can protect the tip 77 from being touched. Referring to FIG. 9, the lock is opened with the key A, the indication block 70 displaces upward and the tip 77 is extended into the hood 80, allowing the indication to be viewed in many surfaces.

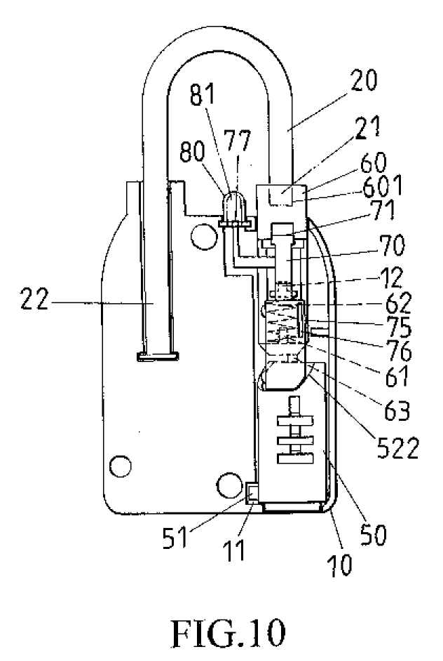

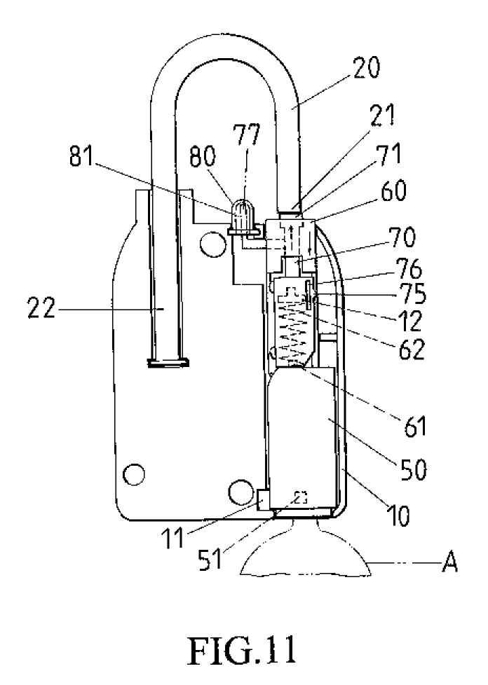

Referring to FIG. 10, wherein the housing 10 of present invention is not provided with the dials and the sleeves, the top of the housing 10 is configured with a hood 80, next to the indication block 70 is extended with the tip 77, and the interior of the hood 80 is provided with the indented hole 81 to hold the tip 77. Referring to FIG. 11, the lock is opened with the key A, the indication block 70 displaces upward, and the tip 77 is extended into the hood 80, allowing the indication to be viewed in many surfaces.

As is apparent from the foregoing, the padlock of the present invention enabling the dials 40 of the housing 10 to open and close the lock, when a combination of number on the dials 40 have placed the lock in a locked state, the inspector use a key can be used to rotate the key tumbler 50 to enable force opening of the lock, from the indicator window 1013 or hood 80 of the housing 10 enables viewing the indication block 70 or tip 80, to confirm whether the inspector has unlocked for examination.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A padlock having an indicator, can be unlocked either by a key or by a number dial, comprising a housing, as well as a shackle and a tube that move relative to the housing; the shackle being provided with a short leg and a long leg; the tube being slided due to rotation of the key; an indication block being placed into the housing and also moved due to the rotation of the key; the indication block being provided with a switch button, and an interior of the tube being provided with a hollow chamber to allow the short leg of the shackle to inset, and also to hold the switch button of the indication block.

2. The padlock having an indicator in accordance with claim 1, wherein a center of the indication block is provided with a baffle block, and the tube is provided with an indented hole into which the baffle block is inserted.

3. The padlock having an indicator in accordance with claim 1, wherein next to the indication block is provided with a bump, an interior of one shell of the housing is provided with two notches for positioning the bump.

4. A padlock having an indicator, can be opened with a key, comprising a hood, a housing, and an indication block which moves relative to the housing, wherein the indication block is provided with a tips and an interior of the hood is provided with an indented hole to hold the tip, enabling the hood to protect the tip from being touched.

5. The padlock having an indicator in accordance with claim 4, wherein the hood is transparent.

6. A padlock having an indicator, can be opened either by a key or by a number dial, comprising a hood, a housing, and an indication block which moves relative to the housing, wherein the indication block is provided with a tip, and an interior of the hood is provided with an indented hole to hold the tip, enabling the hood to protect the tip from being touched.

7. The padlock having an indicator in accordance with claim 6, wherein the hood is transparent.
